(19) United States
(12) Patent Application Publication
(10) Pub. No.: US 2007/0243007 A1
(43) Pub. Date: Oct. 18, 2007

(54) PEN WITH REFILL TIP PROTECTIVE STRUCTURE

(76) Inventors: Yu-Sheng CHANG, Taichung City (TW); Kai-Hsin Chang, Taichung City (TW)

Correspondence Address: BROWDY AND NEIMARK, P.L.L.C.;624 NINTH STREET, NW, SUITE 300, WASHINGTON, DC, 20001-5303, US

(21) Appl. No.: 11/744,584

(22) Filed: May 4, 2007

(30) Foreign Application Priority Data
Mar. 27, 2006 (TW) 95110599

(51) Int. Cl. B43K 7/12; B43K 24/02

(52) U.S. Cl. 401/109

(57) ABSTRACT

A pen of the present invention includes a barrel having a space therein, a refill bore at a front end thereof and at least an opening at a circumference thereof. A refill, which is received in the barrel, has a tip extruded out of the barrel through the refill bore. A tube is received in a gap between the barrel and the refill for reciprocation. An elastic member is received in the barrel to urge the tube outwards so that the tip of the refill is received in the tube in a normal condition. A tube driving mechanism is received in the opening of the barrel and connected to the tube to move the tube inward the barrel for exposing the tip of the refill and compressing the elastic when the tube driving mechanism is pressed. The elastic member returns the tube when the tube driving mechanism is released.

### BACKGROUND OF THE INVENTION

1. Field of the Invention

The present invention relates generally to a pen, and more particularly to a pen capable of protecting the tip of the refill when the pen falls.

2. Description of the Related Art

When a pen, such as pencil, ballpoint pen and felt-tipped pen, falls to the ground, the tip of the pen usually has a serious damage because of the acceleration of gravity. A Taiwan application no. 092209811 provides a pen with a retractable refill to protect the tip of the refill. We found that user has to hold the pen and press the mechanism with strong stength because of the pen's structure and the reactive force of the refill when writing that user has problem to write with the pen.

In conclusion, the conventional pens have many drawback to be improved.

### SUMMARY OF THE INVENTION

The primary objective of the present invention is to provide a pen, which has a tip protective mechanism to prevent the pen from damage.

According to the objective of the present invention, a pen of the present invention includes:

A barrel has a space therein to receive elements of the present invention, a refill bore at a front end thereof and at least an opening at a circumference thereof.

A refill, which is received in the barrel, has a tip extruded out of the barrel through the refill bore.

A tube is received in a gap between the barrel and the refill for reciprocation.

An elastic member is received in the barrel to urge the tube outwards so that the tip of the refill is received in the tube in a normal condition.

A tube driving mechanism is received in the opening of the barrel and connected to the tube to move the tube inward the barrel for exposing the tip of the refill and compressing the elastic when the tube driving mechanism is pressed. The elastic member returns the tube when the tube driving mechanism is released.

The force to move the tube is light so that user holds the pen and presses the tube driving mechanism with less strength that will retract the tube when he/she writes with the pen of the present invention.

### BRIEF DESCRIPTION OF THE DRAWINGS

FIG. 1 is a sectional view of a first preferred embodiment of the present invention, showing the first condition;

FIG. 2 is a sectional view of the first preferred embodiment of the present invention, showing the second condition;

FIG. 3 is a top view in parts of the first preferred embodiment of the present invention;

FIG. 4 is a sectional view along the Y-Y line of FIG. 1;

FIG. 5 is a sectional view of another embodiment of the first preferred embodiment of the present invention, showing the first condition;

FIG. 6 is a sectional view of the another embodiment of the first preferred embodiment of the present invention, showing the second condition;

FIG. 7 is a top view in parts of the another embodiment of the first preferred embodiment of the present invention;

FIG. 8 is a sectional view of a second preferred embodiment of the present invention, showing the first condition;

FIG. 9 is a sectional view of the second preferred embodiment of the present invention, showing the second condition; and

FIG. 10 is a top view in parts of the second preferred embodiment of the present invention.

### DETAILED DESCRIPTION OF THE INVENTION

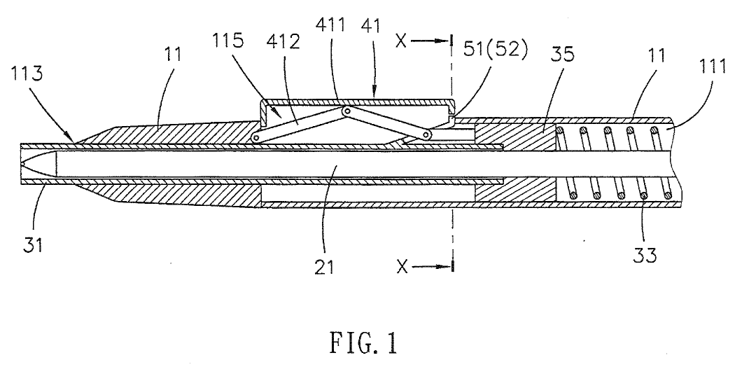

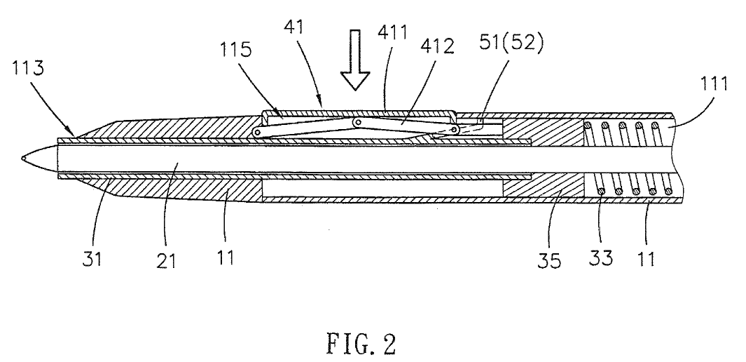

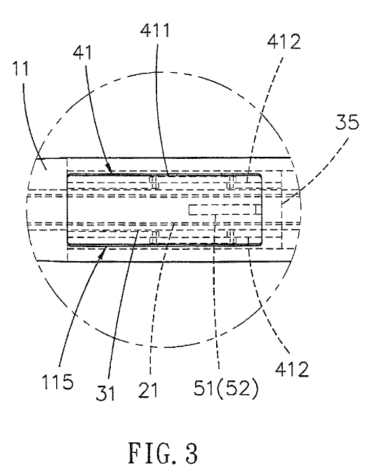

As shown in FIG. 1 to FIG. 4, a pen of the first embodiment of the present invention mainly includes a barrel 11 with a space 111 therein to receive elements of the present invention, a refill bore 113 at a front end thereof and at lest an opening 115 on a circumference thereof.

A refill 21 is received in the barrel 22 with a tip exposed out of the barrel 11 through the refill bore 113. A gap is formed between the refill 21 and the barrel 11.

A tube 31 is received in the gap between the refill 21 and the barrel 11 for reciprocation with a front end exposed out of the barrel 11. An elastic member 33 is received in the barrel 11 and urges a rear end of the tube 31 to have the tip of the refill 21 received in the tube 31 in a normal condition.

A tube driving mechanism 41 is provided in the opening 115 of the barrel 11 and connected to the tube 31. The tube driving mechanism 41 moves the tube 31 inward the barrel 11 when user presses the tube driving mechanism 41 to expose the tip of the refill 21 out of the tube 31 and compress the elastic member 33. The elastic member 33 returns the tube 31 to its initial position to shield the tip of the refill 21 when user releases the tube driving mechanism 41.

The present invention provides two types of the tube driving mechanism 41:

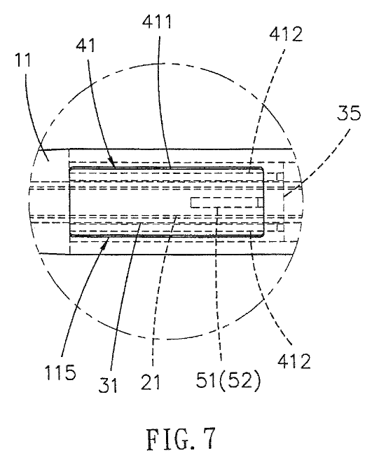

The first tube driving mechanism 41, as shown in FIG. 1 to FIG. 7, includes a button 411 and a transmission device 412 connected to the button 411. The button 411 is extruded out of the opening 115 to be pressed for moving the tube 31 via the transmission device 412.

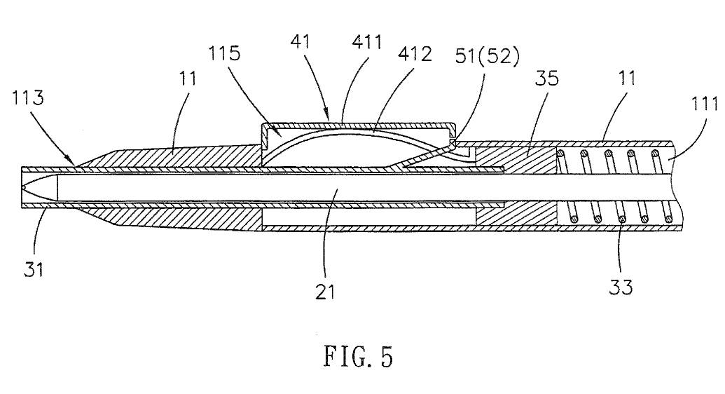

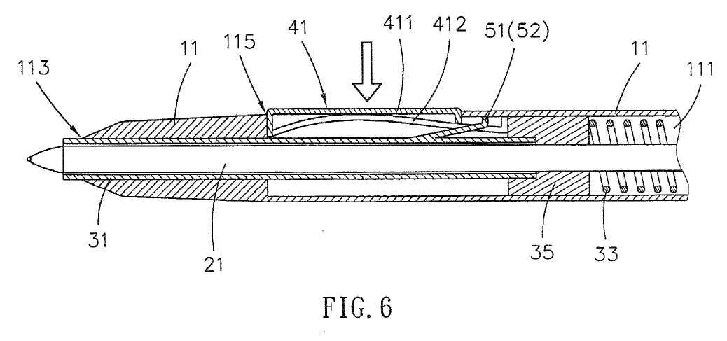

In the first embodiment, we provide two types of the transmission device 412. The first transmission device, as shown in FIG. 1 to FIG. 3, is constructed of a plurality of links pivoted together, and the second transmission device, as shown in FIG. 5 and FIG. 6, is constructed of a curved elastic member, which is made of steel and the alloy thereof, plastic and composite material with well elasticity.

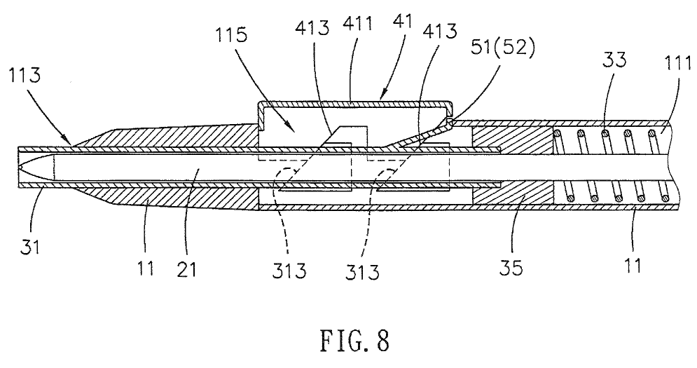

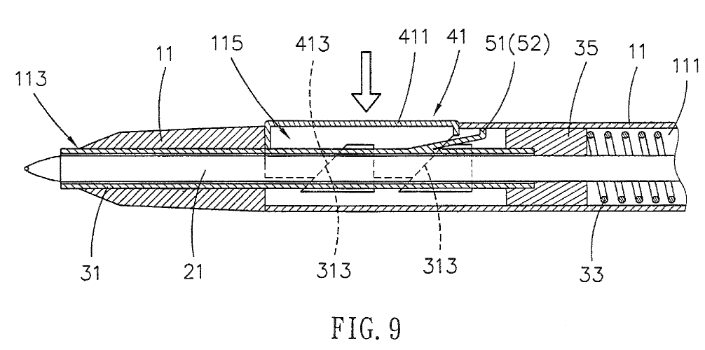

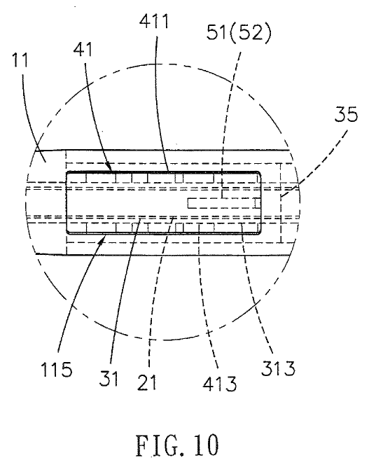

The second tube driving mechanism 41, as shown in FIG. 8 to FIG. 10, includes a button 411 with at least a first sloping mechanism 413. The tube 31 has a second sloping mechanism 313 to be engaged with the first sloping mechanism 413 of the second tube driving mechanism 41 to move the tube 31 when user presses the button 411.

The embodiments as shown in FIG. 1 to FIG. 7 provide a block 35 with at the rear end of the tube 31 to receive the action of the tube driving mechanism 41 and support the elastic member 33. The embodiment as shown in FIG. 8 to FIG. 10 also provides a block 35 with at the rear end of the tube 31 to support the elastic member 33 only.

The present invention further provides a check mechanism 51, which has an elastic device 52, which is a fork-like member, on the tube 31. The elastic device 52 has a rear end pressing the barrel 11 at a position around the opening 115 and a top end adjacent to the button 411 of the tube driving mechanism 41. When user presses the button 411 of the tube driving mechanism 41, the elastic device 52 will be pressed as well to have the top end thereof leaving the barrel 11 that the tube 31 may be moved inwards, or else the tube 31 can not move to prevent the tube 31 from being moved by other except the tube driving mechanism 41. The tube 31 is supported by the elastic device 52 to be kept for shielding the tip of the refill 21 when the button 411 of the tube driving mechanism 41 is not pressed so that the tip will not be damaged when the pen falls.

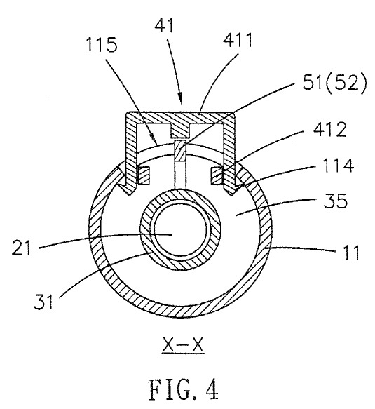

As shown in FIG. 4, the button 411 is provided with two tenons 114 at opposite sides thereof to restrict the button 411 in the opening 115.

The elastic member 33 of the present invention may be a spiral spring to work with the other elements.

The pen of the present invention provides the tube and the tube driving mechanism moving the tube that the tube will be retracted into the barrel automatically when user writes by the pen and the tube will be extruded to protect the refill tip when the pen falls.

The description above is a few preferred embodiments of the present invention and the equivalence of the present invention is still in the scope of the claim of the present invention.

What is claimed is:

1. A pen, comprising:
a barrel having a space therein, a refill bore at a front end thereof and at least an opening at a circumference thereof;
a refill, which is received in the barrel, having a tip extruded out of the barrel through the refill bore;
a tube received in a gap between the barrel and the refill for reciprocation;
an elastic member received in the barrel to urge the tube outwards so that the tip of the refill is received in the tube in a normal condition; and
a tube driving mechanism received in the opening of the barrel and connected to the tube to move the tube inward the barrel for exposing the tip of the refill and compressing the elastic when the tube driving mechanism is pressed; and the elastic member returning the tube when the tube driving mechanism is released.

2. The pen as defined in claim 1, wherein the tube driving mechanism includes a button in the opening of the barrel and a transmission device in the barrel to be moved by the button so that the tube is moved by the transmission device when the button is pressed.

3. The pen as defined in claim 1, wherein the tube driving mechanism includes a button with at least a first sloping mechanism at least a side thereof, and the tube has at least a second sloping mechanism to be engaged with the first sloping mechanism of the button so that the tube is move by an interaction of the first sloping mechanism and the second sloping mechanism when the button is pressed.

4. The pen as defined in claim 1, wherein the tube has a block at a rear end thereof to be driven by the tube driving mechanism and to support the elastic member.

5. The pen as defined in claim 2, wherein the tube has a block at a rear end thereof to be driven by the tube driving mechanism and to support the elastic member.

6. The pen as defined in claim 1, wherein the tube has a block at a rear end thereof to support the elastic member.

7. The pen as defined in claim 3, wherein the tube has a block at a rear end thereof to support the elastic member.

8. The pen as defined in claim 1, further comprising a check mechanism having an elastic device, which is a fork-like member, on the tube with a rear end pressing the barrel at a position around the opening and a top end adjacent to the tube driving mechanism, wherein the elastic device is pressed by the tube driving mechanism to leave the barrel to free the tube for movement inward when the tube driving mechanism is pressed, or else, the tube is restricted by the check mechanism to prevent the tube from being moved when the tube driving mechanism is not pressed.

9. The pen as defined in claim 2, further comprising a check mechanism having an elastic device, which is a fork-like member, on the tube with a rear end pressing the barrel at a position around the opening and a top end adjacent to the tube driving mechanism, wherein the elastic device is pressed by the tube driving mechanism to leave the barrel to free the tube for movement inward when the tube driving mechanism is pressed, or else, the tube is restricted by the check mechanism to prevent the tube from being moved when the tube driving mechanism is not pressed.

10. The pen as defined in claim 3, further comprising a check mechanism having an elastic device, which is a fork-like member, on the tube with a rear end pressing the barrel at a position around the opening and a top end adjacent to the tube driving mechanism, wherein the elastic device is pressed by the tube driving mechanism to leave the barrel to free the tube for movement inward when the tube driving mechanism is pressed, or else, the tube is restricted by the check mechanism to prevent the tube from being moved when the tube driving mechanism is not pressed.

11. The pen as defined in claim 2, wherein the button has two tenons at opposite sides thereof to restrict the button in the opening of the barrel.

12. The pen as defined in claim 3, wherein the button has two tenons at opposite sides thereof to restrict the button in the opening of the barrel.

13. The pen as defined in claim 2, wherein the transmission device is constructed of a curved elastic member.

14. The pen as defined in claim 2, wherein the transmission device is constructed of a plurality of links pivoted together.

15. The pen as defined in claim 1, wherein the elastic member includes a spiral spring.
